(19) United States
(12) Patent Application Publication
(10) Pub. No.: US 2002/0006825 A1
(43) Pub. Date: Jan. 17, 2002

(54) Game system

(76) Inventor: Makoto Suzuki, Shizuoka-ken (JP)

Correspondence Address: BLANK ROME COMISKY & MCCAULEY LLP, THE FARRAGUT BUILDING, SUITE 1000, 900 17TH STREET, NW, WASHINGTON, DC, 20006, US

(21) Appl. No.: 09/901,709

(22) Filed: Jul. 11, 2001

(30) Foreign Application Priority Data
Jul. 11, 2000 (JP) 2000-210391

(51) Int. Cl. G06F 19/00

(52) U.S. Cl. 463/40

(57) ABSTRACT

Disclosed herein is a game system comprising a plurality of game devices. Each game device comprises a position specification section for receiving radio waves from global positioning system (GPS) satellites and then specifying a self-position of the self game device; a information transmission-reception section for transmitting and receiving first positional information on the self game device and second positional information on one other game device of the plurality of game devices between the self game device and the one other game device through a data link; an execution section for executing a predetermined game program, based on the first positional information and the second positional information; and a display section for displaying the game program.

### BACKGROUND OF THE INVENTION

1. Field of the Invention

The present invention relates to a game system, and more particularly to a game system that supports a game, while specifying the positions of a self-device and other devices by taking advantage of radio waves from global positioning system (GPS) satellites.

2. Description of the Related Art

There are a wide variety of game devices that anybody can enjoy regardless of age and sex. However, most of them are performed indoors.

On the other hand, an outdoor leisure activity, such as orienteering, an outdoor game, etc., is obviously healthier due to participants receiving the benefits of exercise. The spread of the indoor game devices tends to deter outdoor activities, so some countermeasure is necessary.

Incidentally, there has been spread of navigation devices for receiving signals (position measuring radio waves) from 4 or more GPS satellites, also measuring its position (latitude, longitude, and altitude) on land, sea, or air, and reading out map information on a current spot from a CD-ROM and displaying the spot on the screen. This navigation device has been developed exclusively as a vehicle guiding device and has hardly been utilized to other applications such as a game, etc.

Conventional game devices have the disadvantage that they are not healthy, because most are enjoyed indoors by displaying a game on the screen, without requiring functional movement of the body.

### SUMMARY OF THE INVENTION

The present invention has been made in view of the circumstances mentioned above. Accordingly, it is the primary object of the present invention to provide a game system which is capable of supporting outdoor games contributing to the upbringing and health promotion of young people.

To achieve this end, there is provided a game system comprising a plurality of game devices, each game device comprising position specification means for receiving radio waves from global positioning system (GPS) satellites and then specifying a self-position of the self game device; information transmission-reception means for transmitting and receiving first positional information on the self game device and second positional information on one other game device of the plurality of game devices between the self game device and the one other game device through a data link; execution means for executing a predetermined game program, based on the first positional information and the second positional information; and display means for displaying the game program.

With this construction, a predetermined game can be executed, while positional information is being transmitted and received between one game device and another game device. For instance, a person with the game device can enjoy a pursuit game or combat game with another person also having another game device. Such a game can be performed only in the fields where radio waves can be received from GPS satellites. Thus, the game system of the present invention is capable of supporting outdoor games contributing to the upbringing and health promotion of young people.

### BRIEF DESCRIPTION OF THE DRAWINGS

The present invention will be described in further detail with reference to the accompanying drawings wherein:

FIG. 1 is a schematic diagram showing a game system constructed according to an embodiment of the present invention;

FIG. 2 is a block diagram showing the construction of the game device shown in FIG. 1;

FIGS. 3 and 4 are diagrams showing how a spy game is started; and

FIGS. 5 to 8 are diagrams showing how the spy game is executed.

### DESCRIPTION OF THE PREFERRED EMBODIMENTS

An embodiment of a game system, comprising a plurality of game devices for supporting a spy game (temporary name), will hereinafter be described in detail with reference to the drawings.

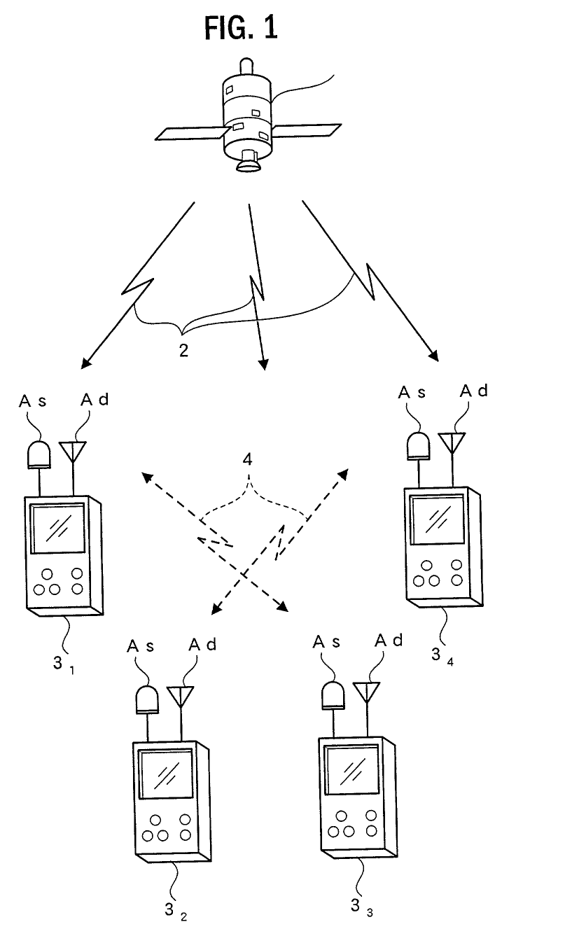

In FIG. 1, the game system of the present invention is equipped with a GPS satellite 1. It is necessary to receive radio waves from 4 or more GPS satellites to obtain positional information, but only one GPS satellite is shown for convenience. The game system is further equipped with n game devices (in the figure, 4 game devices 3₁ to 3₄ (n=4) are shown for convenience). The game devices 3₁ to 3₄ are disposed at arbitrary spots where a radio wave 2 from the GPS satellite 1 can be received.

Each of the n game devices 3ᵢ (where i=1, 2, . . . , and n) receives the radio wave 2 from the GPS satellite 1 and makes a calculation of a self-position, and executes a predetermined game program, while exchanging data with another game device through a radio data link 4. During execution of the game program, the game device 3ᵢ has the role of either a spy or a defense team member. The “spy” in this embodiment has the duty of performing a command given at the time of game start, while the “defense team member” has the duty of disturbing (finding, arresting, or repulsing) spy activity. The function of these roles, etc., is realized by an organic combination of hardware that constitutes the game devices 3ᵢ and a game program that operates on the game devices 3ᵢ. Note that the game device 3ᵢ should be housed in a body that is as light and small as possible in consideration of ease of motion, because it is carried by a game participant.

The game device 3ᵢ, as previously described, is capable of receiving the radio wave 2 from the GPS satellite 1 individually and also at least communicating with another game device 3ᵢ. For instance, the game device 3₁ has the function of receiving the radio wave 2 from the GPS satellite 1 and the radio wave 4 from the other game devices 3₂ to 3₄ and also transmitting the radio wave 4 to the other game devices 3₂ to 3₄. The game device 3ᵢ has an antenna As for receiving the radio wave 2 from the GPS satellite 1 and an antenna Ad for transmitting and receiving the radio wave 4. If possible, they should be united into a single common antenna. The reason for this is that it makes a contribution to a reduction in size and does not disturb the progress of a game.

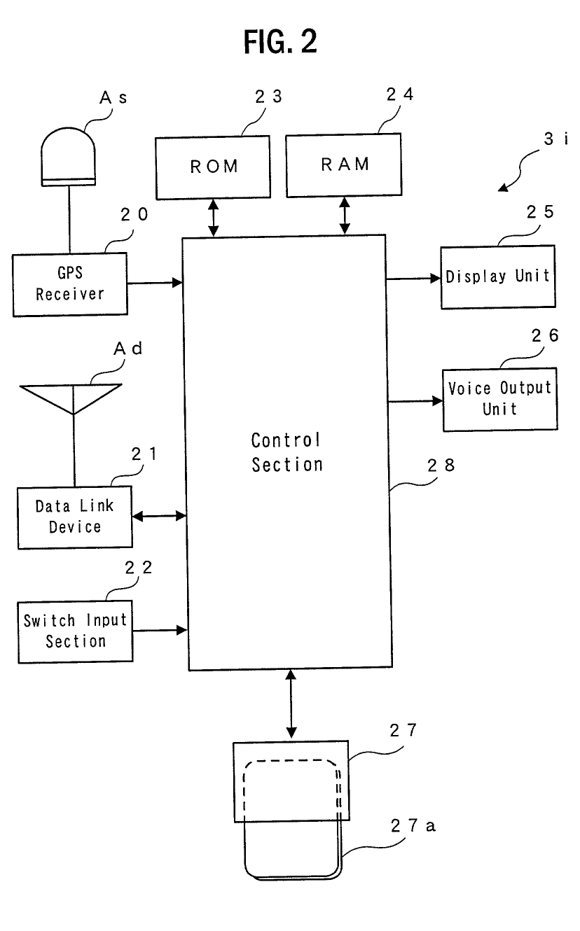

FIG. 2 shows the construction of the game device 3ᵢ. As shown in the figure, the game device 3ᵢ is constructed of two antennae As, Ad, a GPS receiver 20, a data link device 21, a switch input section 22, a read-only memory (ROM) 23, a random access memory (RAM) 24, a display unit 25, a voice output unit 26, a card reading section 27, and a control section 28.

The antenna As is used for receiving the radio wave 2 from the GPS satellite 1, and the antenna Ad is used for transmitting and receiving the radio wave 4 between the game devices 3ᵢ. The radio wave 2 from the GPS satellite 1 is prescribed as an L1-radio wave of frequency 1575.42 MHz, wavelength about 19 cm, and spectrum diffusion modulation by the National Military Establishment of the United States. For the radio wave 4 for a data link, an optimal one can be selected within the Rules of the Wireless Telegraphy Act. That is, a suitable frequency can be selected from among the frequencies allotted to mobile communication, in consideration of a data transmission quantity, a communication range, an antenna scale (possibility of common use with an antenna for satellite communication),etc. Therefore, in this embodiment, a description of the quality (frequency, method of modulation, etc.) of a radio wave for a data link will not be given.

The GPS receiver 20 executes the following four tasks primarily. That is, the GPS receiver 20 executes a first task of determining 4 or more satellites which are caught based on orbital information on all satellites; a second task of receiving L1-radio waves from the 4 or more satellites caught and calculating a position of each satellite and a pseudo range to each satellite; a third task of reading a satellite message (or navigation message) contained in the L1-radio waves and updating the aforementioned orbital information; and a fourth task of specifying the coordinates ((1) latitude and longitude, or (2) latitude, longitude, and altitude) of a self-position (also called a received point) from the calculated pseudo range to each satellite. Some of these tasks (particularly the fourth task) can be performed in a software manner by the control section 28. However, in this embodiment, as described above, the four tasks are executed in the GPS receiver 20 for the convenience of explanation.

The data link device 21 controls the transmission of information to one other game device 3ᵢ. Therefore, assuming an information link to one other device 3ᵢ is a down link and that information link from the one other game device 3ᵢ is an up link, the data link device 20 reads a game device address (identification number for each game device) contained in the up link and specifies the game device 3ᵢ requesting information, and also generates the information requested by the game device 3ᵢ and transmits the information to the game device 3ᵢ through the down link. The game device 3ᵢ has an “event-driven transmission mode” in which the aforementioned information transmission is performed in response to a calling event from one other game device 3ᵢ. In addition, the game device 3ᵢ may have a “spontaneous transmission mode” in which necessary information is transmitted to one other game device 3ᵢ or specific game device 3ᵢ, regularly, or when predetermined conditions are met. An information transmitting method and protocol are not particularly limited. However, considering efficient information transmission between a plurality of game devices 3ᵢ, the utilization of a transfer method, such as packet communication in which a fixed quantity of information, containing sender identification information, receiver identification information, and error detection code, is transferred with time multiplexing or frequency multiplexing, is preferred.

The switch input section 22 includes a variety of switches provided in the main body of the game device 3ᵢ. These switches, in addition to performing a manipulation of measuring the position of the game device 3ᵢ, are used to perform various manipulations needed for execution of the game program, maintenance of various information, etc.

The ROM 23 semi-permanently stores an operating system (OS) needed for operation of the game devices 3ᵢ, a wide variety of applications programs, and data. The RAM 24 provides a storage space necessary for execution of the OS and application programs and also provides a temporary storage space for temporary data.

The display unit 25 is a thin, lightweight, and low-power flat display unit (typically, a liquid crystal display), and graphically displays a self-position and positions of other game devices 3ᵢ and also displays a game screen and a system management screen. Note that if a touch panel is installed on the display screen so that the coordinates of an arbitrary position on the display panel is displayed when touched with a pen or finger, it is preferable because it reinforces or supplements the functions of the switch input section 22.

The voice output unit 26 is not always needed, but is an auxiliary device for sending out a warning sound or guide voice during operation of the game devices 3ᵢ, or sending out an informing sound to inform a call from one other game device 3ᵢ.

The card reading section 27 is used for reading out a game program (e.g., the spy game in this embodiment) stored in a card storage medium 27a.

Finally, the control section 28 controls operation of the game device 3ᵢ and is constructed typically of a microcomputer. The control section 28 executes a program stored in the ROM 23, or a program read out by the card reading section 27, in response to a manipulation event from the switch input section 22 (and, in the case having a touch panel, a touch event) or a calling event from one other game device 3ᵢ, and then realizes various process functions in a software manner.

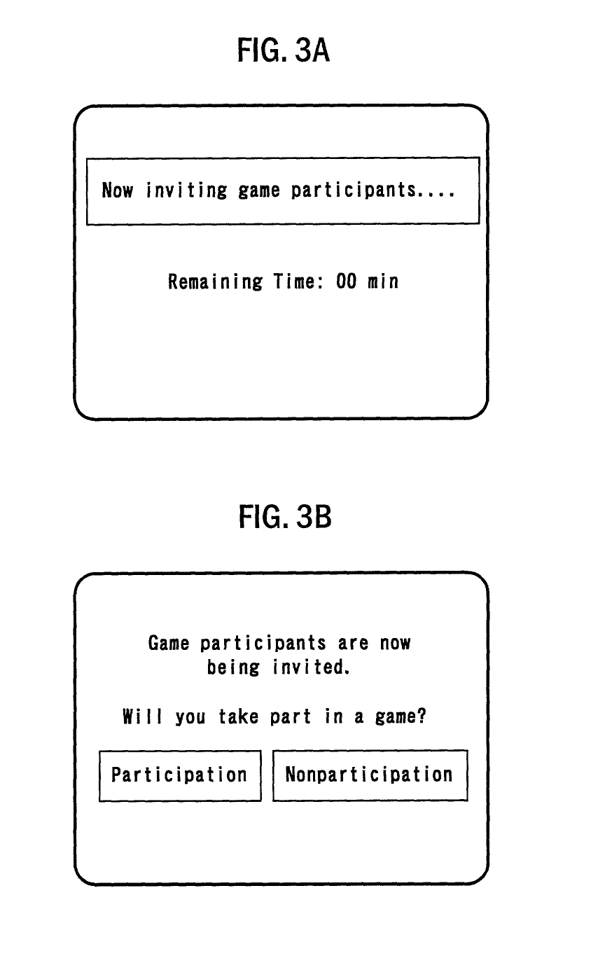

The screen display examples of the game devices 3ᵢ during execution of the spy game are shown in FIGS. 3 to 8. Initially, if the game program is started, an invitation screen for game participants is displayed. FIG. 3A shows the screen of a game device that first started the game program, and FIG. 3B shows the screen of each of the other game devices. In FIG. 3A, it is displayed that game participants are now being invited to join, and in addition the time remaining until the close of the invitation is displayed. In FIG. 3B, there is shown a screen inquiring about participation of the game, and a participant selects “participation” displayed on the screen.

The game will be materialized if there is at least one participant other than a declarer of game start (who is an owner of the game device that first started the game program). The declarer will hereinafter be also referred to as a participant.

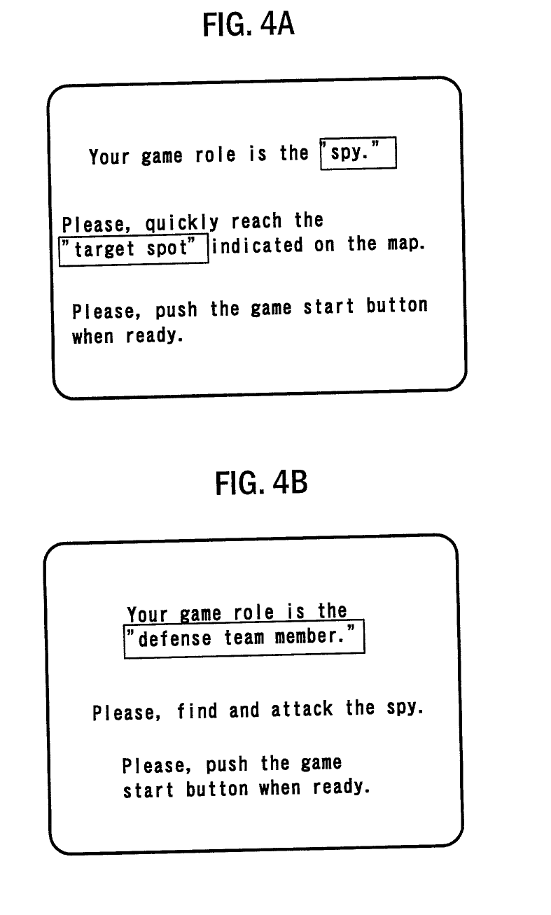

If the game is materialized, the screen display for all participants is as shown in FIG. 4. This screen indicates the allotment of roles on the game. For example, FIG. 4A shows the role of a “spy” and FIG. 4B shows the role of a “defense team member. The role allotment is performed automatically by the transmission and reception of information between game devices. In the predefined mode, one spy is allotted to any one of the participants, and defense team members are allotted to the remaining participants. However, to make the game complicated, the game may be programmed so that a multiple-spy mode can be selected. In FIG. 4A, a spy is instructed to reach a target spot shown on the map. However, this is merely an example. In the case of the multiple-spy mode, a spy may be instructed to acquire necessary information from other spies.

If roles are allotted to participants, the game will begin. If each participant depresses a predetermined button (game start button) in his or her game device, and all participants complete button manipulation, the game is started.

During the preparation mentioned above, the participants do not need to meet together. It will be sufficient if they are situated within a range in which data can be transmitted through data links. It is rather preferable that participants not be seen, because a game becomes more exciting.

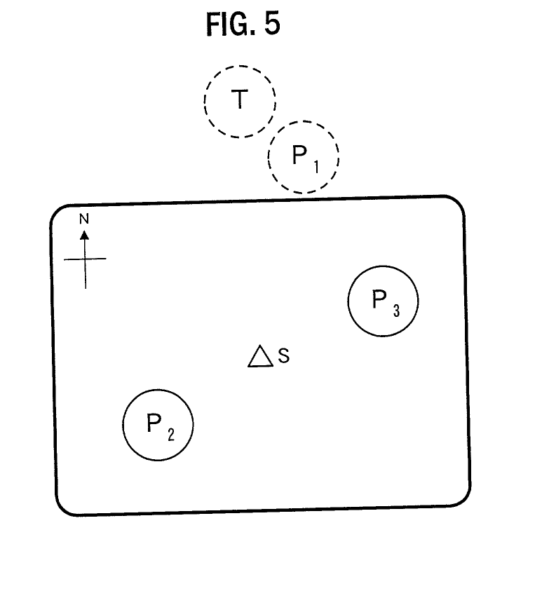

A display example of the screen during the game is shown in FIG. 5. In the figure, reference character S denotes a spy, P a defense team member, and T a target spot that the spy is instructed to reach. A subscript figure represents an identification number. A triangular mark indicates a self-position, and circular marks indicate positions of other participants. The circular marks are larger than the triangular mark for a self-position. This is because if positions of other participants are roughly displayed, the game will become more exciting. Note that the size of the circular mark may be gradually reduced according to the progress of the game. In this case, positions of other participants can be easily specified and the excitement of the game increases.

In the display screen of FIG. 5, two marks are situated outside the display frame. One is a defense team member (P₁) and another is a target (T). The subscript notation Δₛ in FIG. 5 shows that a person having the game device of the display screen has the role of a spy. Therefore, the person must find the target T, as instructed. However, since at this state the target T is still outside the display frame, the person first has to move so that the target T is moved within the display frame, while avoiding an encounter with defense team members.

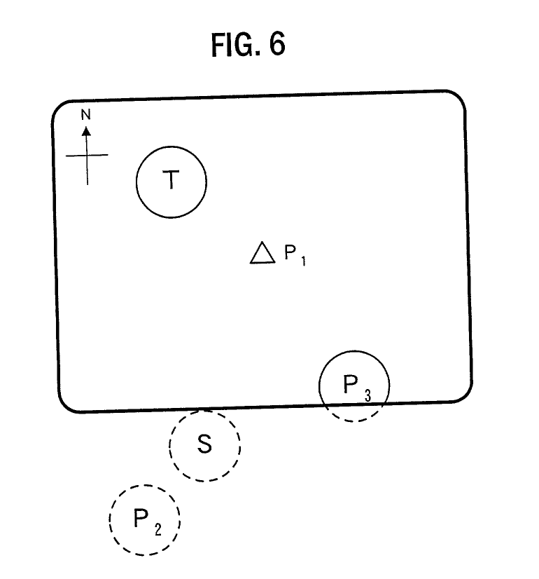

On the other hand, a display example for the defense team member P₁ is shown in FIG. 6. In this display example, the entire target T and part of the defense team member P₃, in addition to the defense team member P₁, are within the display frame. The remaining spy S and defense team member P₂ are situated outside the display frame. Therefore, at this stage, the defense team member P₁ cannot specify the position of the spy S. If the spy S moves so that the target T is displayed on the display screen, the defense team member P₁ near the target T will also be displayed on the display screen. Furthermore, the position of the spy S will be displayed on the display screen of the game device that the defense team member P₁ has.

Therefore, the spy S tries to approach the target T, while avoiding being pursued by the defense team member P₁. On the other hand, the defense team member P₁ tries to predict movement of the spy S and find the spy S. If the spy S avoids being pursed by the defense team member P₁ and then reaches the target T, the spy S wins the game. If the defense team member P₁ finds the spy S and arrests or attacks and makes the spy immovable, the defense team member P₁ wins the game.

As has been described above, this embodiment is capable of making a contribution to the upbringing and health promotion of young people, because it provides an outdoor game system by taking advantage of radio waves from GPS satellites.

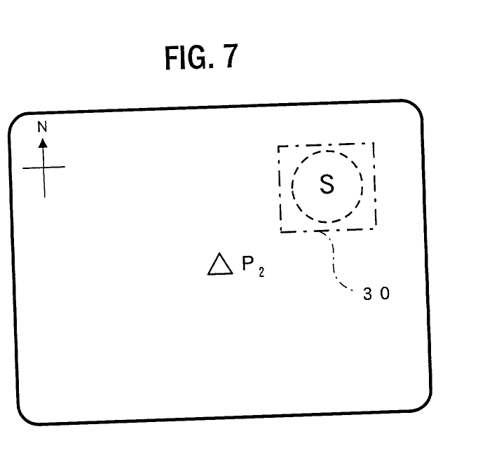

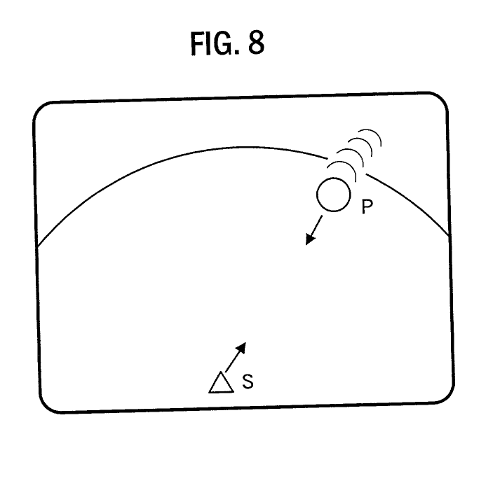

While the present invention has been described with reference to the preferred embodiment thereof, the invention is not to be limited to the details given herein, but may be modified within the scope of the invention hereinafter claimed. As shown in FIG. 7, for example, an imaginary safety zone 30 may be provided in a specific area. In this case, the spy S is not displayed on other game devices, as long as it is within the zone 30. Also, when the distance between the spy S and the defense team member P is within a predetermined value, as shown in FIG. 8, they may attack each other in a combat mode. In addition, the defense team member may inform other defense team members of being attacked, and request back-up. Furthermore, the specification of the position is not limited to utilization of the GPS satellites. The position of the spy S may be displayed on the screen for the defense team member P regularly or at random intervals, instead of being displayed at all times. Some questions can be displayed on the screen. In this case, the game program may be set so that if the answer is incorrect, the person cannot continue the game, or the remaining time is decreased, or the display accuracy of the screen is reduced, or the kinds of weapons are diminished.

What is claimed is:

1. A game system comprising a plurality of game devices, each game device comprising
position specification means for receiving radio waves from global positioning system (GPS) satellites and then specifying a self-position of the self game device;
information transmission-reception means for transmitting and receiving first positional information on said self game device and second positional information on one other game device of said plurality of game devices between said self game device and said one other game device through a data link;
execution means for executing a predetermined game program, based on said first positional information and said second positional information; and
display means for displaying said game program.
